(19) United States
(12) Patent Application Publication
(10) Pub. No.: US 2025/0390735 A1
(43) Pub. Date: Dec. 25, 2025

(54) UNKNOWN CLASS AWARE, PRIVACY PRESERVING, CUSTOMIZABLE AND SCALABLE SENSITIVE DOCUMENT CLASSIFICATION SYSTEM

(71) Applicant: HUAWEI TECHNOLOGIES CO., LTD., Shenzhen (CN)

(72) Inventors: Jinxin LIU, Waterloo (CA); Tongyu GE, Waterloo (CA); Zao YANG, Waterloo (CA); Ting PAN, Waterloo (CA)

(21) Appl. No.: 18/752,991

(22) Filed: Jun. 25, 2024

(51) Int. Cl. G06N 3/08; G06F 16/906; G06F 16/93

(52) U.S. Cl. CPC G06N 3/08; G06F 16/906; G06F 16/93

(57) ABSTRACT

A method and processor for classifying documents are provided. Using a classification model with classifiers, items are classified into classes. The method includes acquiring a model for classification, creating a training dataset with items and class labels, and training a new classifier for an additional class not in the original set. This results in a modified model that includes both the original classifiers and the new classifier, allowing for classification into an expanded set of classes. The method involves generating a training dataset, training a new classifier, modifying the classification model, and determining a predicted class for items, including the new class.

### FIELD

The present technology is generally related to document classification systems, and more specifically, to the development of sensitive document classification systems using models for improved accuracy and adaptability in classifying various document types.

### BACKGROUND

In recent years, the importance of establishing robust systems for securely classifying and managing sensitive documents across various industries has become increasingly recognized. This need is driven by the growing complexity and volume of information, coupled with heightened concerns over data privacy, security, and regulatory compliance. To address these challenges, comprehensive frameworks outlining the processes and criteria for effective categorization and protection of sensitive documents need to be developed. Such frameworks should specify methods for identifying different categories of documents, defining clear guidelines for their handling, and setting forth requirements for processors of personal information to manage it in a categorized and secure manner. The implementation of these systems is crucial for ensuring the confidentiality, integrity, and availability of sensitive information, thereby safeguarding against unauthorized access and data breaches while promoting regulatory adherence.

In light of these considerations, at least some techniques have been developed to classify sensitive documents, such as Google Sensitive Data Protection, Microsoft Purview, and CyberSeveral's Qingzhi Data Detection and Response (DDR) System. Typically, sensitive document classification systems ingest documents in various formats (e.g., Portable Document Format (PDF), images, and Office files) as inputs, extract modalities (e.g., text and images), and employ classifiers to predict the categories of the given documents, such as ‘Transaction Record’, ‘Illegal Record’, and ‘Normal’.

Recently, models such as Bidirectional Encoder Representations from Transformers (BERT) and Generative Pretrained Transformer (GPT) have been used in the solutions used for document classification. Certain solutions within this field enable the classification of previously unseen documents by constructing a unique classifier for each new class identified, a process which can be time-consuming.

Some other solutions within this field enable the classification of previously unseen documents by facilitating the development of customizable machine learning (ML) classifiers. This customization can be achieved through methods such as creating individual classifiers for each new class or by using statistical ML techniques like Term Frequency-Inverse Document Frequency (TF-IDF) to extract keywords and match them for new classifier creation. While some technologies are capable of classifying unknown documents, not every system allows for the modification or creation of new ML classifiers. Although this method provides more flexibility in classification, the accuracy of such systems can be compromised due to the limitations inherent to statistical ML algorithms.

Furthermore, some solutions within this field encompass deep learning models that predict classes using linear layers regardless of the base architecture, such as BERT, Long Short-Term Memory (LSTM) networks, or Convolutional Neural Networks (CNNs). These models face challenges in adapting to new class information over time, a concept referred to in the field as the ability to learn incrementally without retraining from the ground up for each new class.

Despite recent advancements, document classification models struggle to effectively combine the identification of unknown classes.

### SUMMARY

Developers have devised methods and devices for overcoming at least some drawbacks present in prior art solutions.

Developers of the present technology have designed a document classification system that may tackle some of the challenges of unknown class classification and Class Incremental Classifier (CIL). For unknown class classification, the training set may include a narrow range of typical ‘Normal Documents’. Non-typical ‘Normal Documents’ that do not appear in the training data may be identified to reduce the false alarms. CIL allows updating existing classifiers to accommodate new classes without necessarily compromising their performance (in terms of accuracy or F1 score) on the original classes. With this technique, users may add new classifiers or revise original classifiers to better fit their needs.

The present technology may have a variety of advantages. First, in some embodiments of the present technology, a processor may identify unseen ‘Normal Class’ with better performance and lower false alarm rates. Second, the present technology may incorporate customizable classifiers. For example, users can customize or add their own classifiers by providing example documents. Third, the present technology may incorporate privacy preserving training techniques for classification models. In conventional approaches, when multiple data owners possess diverse classes of documents, the training and fine-tuning processes necessitate collaboration among these parties or model trainer, often leading to the disclosure of sensitive information. Nevertheless, the present technology may permit various data owners to conduct local training using their respective datasets, eliminating the need for direct raw data exchange. Only trained models or predicted probability outputs may be able to be shared between the involved parties. This method may reduce the risk of data leakage while maintaining efficiency in the training process. Fourth, the present technology may be implemented in a scalable and resource efficient manner. For example, the processor may train light-weight classifiers without using considerable computational resources (e.g., time, Central Processing Unit (CPU), Graphics Processing Unit (GPU) and memory) if compared to some other known techniques.

Some implementations of the present technology can be used by systems that require document classification including Data Subject Request (DSR) Systems, Data Storage/Management Systems, Data Access Control Systems, etc.

In the context of the present technology, sensitive document classification systems refer to systems developed for categorizing documents based on their sensitivity level. These systems process documents in multiple formats, extract relevant data, and use classification algorithms to determine the category of each document, such as transaction record, illegal record, normal record, etc.

In the context of the present technology, classifiers refer to algorithms or models that categorize or label documents into predefined classes based on the features extracted from the documents. These can range from traditional machine learning models to advanced deep learning models.

In the context of the present technology, unknown class classification refers to the challenge of correctly identifying documents that belong to classes not seen during the training phase of a model, reducing false alarm rates by recognizing non-typical Normal Documents.

In the context of the present technology, the F1 score refers to a harmonic mean of precision and recall, providing a balance between the two metrics for evaluating the accuracy of a document classification system. Specifically, it measures the test's accuracy considering both the precision (the number of correctly identified positive results divided by the number of all positive results predicted by the classifier) and the recall (the number of correctly identified positive results divided by the number of all relevant samples or documents that should have been identified as positive). This metric is particularly useful in scenarios where the balance between precision and recall is critical, such as in classifying sensitive documents where both false positives and false negatives carry significant consequences. The F1 score is calculated as follows:

$$F 1 score = \frac{2 * precision * recall}{precision + recall} \qquad ( 1 )$$

In the context of the present technology, machine learning algorithms refer to a set of algorithms and statistical models used by computer systems to perform specific tasks without using explicit instructions. Instead, they rely on patterns and inference derived from data. In document classification systems, machine learning algorithms analyze and learn from training data to classify documents into predefined categories based on their content, including text and images.

In the context of the present technology, deep learning models refer to a class of machine learning algorithms that use multiple layers of nonlinear processing units for feature extraction and transformation, learning from vast amounts of data.

In the context of the present technology, transformer-based models refer to a type of deep learning model that uses self-attention mechanisms to process sequential data, such as text, and has shown superior performance in various Natural Language Processing tasks. Unlike its predecessors that process data sequentially, transformer models assess the importance of different parts of the input data relative to each other, enabling the model to focus on the most relevant information for the task at hand.

In the context of the present technology, the self-attention mechanism refers to a computational technique used within neural network architectures, such as transformers, that enables the model to weigh the importance of different parts of the input data relative to each other. This mechanism calculates attention scores by comparing each element in the input sequence with every other element to determine how much focus should be placed on other parts of the data when processing a specific part. By doing so, self-attention allows the model to dynamically adjust its focus on the most relevant information for the task at hand, significantly enhancing its ability to understand complex relationships and dependencies in data.

In the context of the present technology, Class Incremental Classifier (CIL) refers to a technique that allows the updating of existing classifiers to include new classes without degrading the performance on previously trained classes, enabling customization and adaptation to new data.

In the context of the present technology, privacy preserving training refers to a methodology where multiple data owners can train models on their respective datasets without directly sharing sensitive information, thus minimizing the risk of data leakage.

In the context of the present technology, feature extraction refers to the process of transforming raw data (text, images, etc.) into a set of numerical features that can be used by a classifier to predict the document's category.

In the context of the present technology, Natural Language Processing (NLP) models refer to deep learning-based models specifically designed for understanding, interpreting, and generating human language.

In the context of the present technology, Computer Vision (CV) models refer to deep learning models that are designed to interpret and understand visual information from the world, converting it into a form that can be processed and analyzed.

In the context of the present technology, multi-modal models refer to models that can process and integrate information from multiple types of data, such as text and images, to better understand and classify documents.

In the context of the present technology, Bidirectional Encoder Representations from Transformers (BERT) refers to a model in Natural Language Processing that uses the Transformer architecture for generating bidirectional context for any given word by analyzing the words that come before and after it. It is designed to pre-train deep bidirectional representations from unlabeled text by jointly conditioning on both left and right context in all layers.

In the context of the present technology, Convolutional Neural Network (CNN) refers to a class of deep neural networks, most commonly applied to analyzing visual imagery. They use a mathematical operation called convolution in at least one of their layers. CNNs are designed to automatically and adaptively learn spatial hierarchies of features from input images.

In the context of the present technology, Recurrent Neural Network (RNN) refers to a type of neural network where connections between nodes form a directed graph along a temporal sequence. This allows it to exhibit temporal dynamic behavior and use its internal state (memory) to process sequences of inputs. This makes RNNs particularly useful for tasks where the context or the sequence in which data is presented is important.

In the context of the present technology, Long Short-Term Memory (LSTM) refers to a type of Recurrent Neural Network (RNN) architecture that is designed to recognize patterns in sequences of data, such as numerical time series data, natural language, or complex sequences like handwriting and speech. Unlike standard feedforward neural networks, LSTMs have feedback connections that make them capable of processing entire sequences of data, enabling them to capture long-term dependencies and remember information for an extended period. This is achieved through a sophisticated system of gates that regulate the flow of information in and out of the memory cell, addressing the vanishing gradient problem common in traditional RNNs. This makes LSTMs particularly effective for tasks that require the understanding of context over time, such as language translation, speech recognition, and predictive typing.

In the context of the present technology, Robustly Optimized BERT Pretraining approach (ROBERTa) refers to a Natural Language Processing (NLP) model which builds upon the transformer architecture introduced by BERT with key improvements in training methodology, data size, and computational resources. ROBERTa optimizes the BERT pre-training process by training on a larger dataset for a longer duration, removing the next-sentence prediction objective, and dynamically changing the masking pattern applied to the training data. These enhancements enable ROBERTa to achieve superior performance on a wide range of NLP tasks, including sentiment analysis, question answering, and text classification.

In the context of the present technology, cosine similarity refers to a metric used to measure the similarity between two non-zero vectors of an inner product space that helps in identifying and extracting text content from Portable Document Format (PDF) files. By comparing the cosine of the angle between text content vectors extracted from PDF documents, this approach quantifies similarity, with values closer to 1 indicating high similarity and values closer to 0 indicating low similarity. This technique is particularly useful for processing and analyzing large volumes of PDF documents, enabling the text extraction model to efficiently determine and extract relevant text content by comparing the semantic similarity of textual data within the documents.

In the context of the present technology, Vision Transformer (ViT) refers to an approach for processing images by applying the principles of transformers. Unlike traditional Convolutional Neural Networks (CNNs) that process images through localized filters, ViT divides an image into fixed-size patches, linearly embeds each of them, and then processes the sequences of patches using a transformer architecture. This enables ViT to capture both local and global dependencies within the image, leading to significant improvements in image recognition tasks. By leveraging the self-attention mechanism, ViT can focus on the most relevant parts of the image for a given task, making it highly efficient and adaptable to a wide range of computer vision applications.

In the context of the present technology, the extreme Gradient Boosting (XGBoost) model refers to a machine learning algorithm that is designed to enhance the speed and performance of gradient boosting frameworks. It operates by constructing a series of decision trees in a sequential manner, where each successive tree aims to correct the errors made by the previous ones. This process is governed by a gradient descent algorithm to minimize a loss function, making it particularly effective for both regression and classification problems.

In the context of the present technology, the Multilayer Perceptron (MLP) model refers to a class of feedforward artificial neural network that consists of at least three layers of nodes: an input layer, one or more hidden layers, and an output layer. Each node in one layer connects with a certain weight to every node in the following layer, facilitating the network's ability to learn complex patterns in data through the process of adjusting these weights based on the error of the output compared to the expected result. This adjustment is typically achieved through a process known as backpropagation. MLPs are widely utilized for solving problems that require supervised learning as well as for classification and regression tasks.

In the context of the present technology, Generative Pre-trained Transformer (GPT) refers to a type of Transformer-based model designed for natural language understanding and generation. It is pre-trained on a large corpus of text data to generate human-like text based on the input it is given.

In the context of the present technology, Term Frequency-Inverse Document Frequency (TF-IDF) refers to a statistical measure used to evaluate the importance of a word in a document relative to a collection of documents or corpus. It is often used in text mining and information retrieval.

In the context of the present technology, Support Vector Machine (SVM) refers to a supervised machine learning model that is used for classification and regression tasks. It works by finding the hyperplane that best divides a dataset into classes.

In the context of the present technology, adaptive thresholding combined with contour detection for image preprocessing refers to a model used to enhance the visibility and distinguishability of objects within images by dynamically adjusting the threshold for converting grayscale images to binary (black and white) images, and then detecting the precise boundaries of objects within these binary images.

In the context of the present technology, Optical Character Recognition (OCR) refers to a tool or technology that converts different types of documents, such as scanned paper documents, PDF files, or images captured by a digital camera, into editable and searchable data by recognizing text within the documents.

In the context of the present technology, Portable Document Format (PDF) readers refer to software or tools designed to open, view, and sometimes edit PDF files, facilitating the extraction of text and images for further processing in document classification systems.

In the context of the present technology, a hyperparameter refers to a configuration variable that is set prior to the training process and is used to control the behavior of the classification model. These hyperparameters are not derived from the data during training but are predetermined values that influence the model's architecture, its learning process, and ultimately, its performance. Examples of hyperparameters include the threshold for classifying a document as belonging to an unknown class, the learning rate for optimization algorithms, the size of the batch of documents processed by the model at one time etc. The selection and tuning of hyperparameters are crucial for optimizing the model's ability to accurately classify documents while efficiently managing resources like computational time and memory.

In at least one aspect of the present technology, there is provided a method for classifying documents. The method is executable by a processor. The method comprises acquiring a classification model including a set of classifiers, the classification model for classifying a given item as being of one of a set of classes, a first classifier from the set of classifiers being configured to classify a given item as being of at least one of a first class and an other class, the first class amongst the set of classes being unique to the first classifier amongst the set of classifiers; generating a training dataset including a plurality of training items with associated class labels, the plurality of training items having a new item associated with a class label, the class label being indicative of a new class, the new class being mutually exclusive with the set of classes; training a new classifier using the training dataset for classifying the given item as being of at least one of the new class and the other class; generating a modified classification model based on the classification model and the new classifier, the modified classification model including an augmented set of classifiers, the augmented set of classifiers having the set of classifiers and the new classifier, the modified classification model for classifying the given item as being one of an augmented set of classes, the augmented set of classes including the set of classes and the new class.

It is contemplated that the present technology is customizable due to its ability to generate a modified classification model with an augmented set of classifiers. Users can tailor the model by adding their own classifiers through the provision of example documents.

It is also contemplated that the present technology is scalable due to its ability to augment the set of classifiers included in the classification model. This scalability allows the technology to identify unseen ‘Normal Class’ instances with improved performance and reduced false alarm rates.

It is also contemplated that the present technology may be implemented in a resource-efficient manner. For instance, the processor can train lightweight classifiers without using considerable computational resources such as time, Central Processing Unit (CPU), Graphics Processing Unit (GPU), and memory compared to some other known techniques.

In some embodiments of the method, the method further comprises determining a predicted class for the given item using the modified classification model, the predicted class being the new class.

In some embodiments of the method, the first classifier is a first binary classifier configured to classify the given item as being of the first class or the other class.

In some embodiments of the method, the first class is a plurality of first classes, the plurality of first classes being unique to the first classifier amongst the set of classifiers.

In some embodiments of the method, the new classifier is a new binary classifier configured to classify the given item as being of the new class or the other class.

In some embodiments of the method, the new class is a plurality of new classes, the plurality of new classes being mutually exclusive with the set of classes.

In some embodiments of the method, determining the predicted class further comprises submitting the given item to each classifier within the augmented set of classifiers; obtaining individual classification outputs from each classifier; determining the predicted class of the given item using the individual classification outputs.

In some embodiments of the method, the method further comprises extracting modality data from the given item using a modality extractor model; extracting a plurality of features from the modality data using a feature extractor model. Furthermore, determining the predicted class comprises inputting the plurality of features into the modified classification model; and outputting by the modified classification model, the predicted class for the given item.

In some embodiments of the method, the new classifier is at least one of: Support Vector Machine (SVM) model, eXtreme Gradient Boosting (XGBoost) model, Multilayer Perceptron (MLP) model, Convolutional Neural Network (CNN), Recurrent Neural Network (RNN), and Transformer-based model.

In some embodiments of the method, the modality data includes at least one of: text, images, charts and tables.

In some embodiments of the method, the modality extractor model is at least one of: Long Short-Term Memory (LSTM) network for character recognition in Optical Character Recognition (OCR) tasks; a text extraction model for extracting text content from Portable Document Format (PDF) files.

In some embodiments of the method, the feature extractor model is at least one of: Bidirectional Encoder Representations from Transformers (BERT), Vision Transformer (ViT), Robustly Optimized BERT Pretraining approach (ROBERTa), and Generative Pretrained Transformer (GPT).

In some embodiments of the method, the set of classes include ‘Transaction Record’, ‘Illegal Record’, ‘Normal’, and the new class includes ‘Custom Class’.

In some embodiments of the method, the method further comprises training the classification model on a given training dataset for classifying new items using a remote processor; providing the classification model to the processor instead of the given training dataset.

It is contemplated that the present technology may incorporate privacy-preserving training techniques for classification models. In conventional approaches, multiple data owners with diverse classes of documents must collaborate during training and fine-tuning processes, often leading to the disclosure of sensitive information. However, the present technology allows various data owners to conduct local training using their respective datasets, eliminating the need for direct raw data exchange. Only trained models or predicted probability outputs may be shared between the involved parties, reducing the risk of data leakage while maintaining efficiency in the training process.

In at least one aspect of the present technology, there is provided a processor for classifying documents. The processor is configured to acquire a classification model including a set of classifiers, the classification model for classifying a given item as being of one of a set of classes, a first classifier from the set of classifiers being configured to classify a given item as being of at least one of a first class and an other class, the first class amongst the set of classes being unique to the first classifier amongst the set of classifiers; generate a training dataset including a plurality of training items with associated class labels, the plurality of training items having a new item associated with a class label, the class label being indicative of a new class, the new class being mutually exclusive with the set of classes; train a new classifier using the training dataset for classifying the given item as being of at least one of the new class and the other class; generate a modified classification model based on the classification model and the new classifier, the modified classification model including an augmented set of classifiers, the augmented set of classifiers having the set of classifiers and the new classifier, the modified classification model for classifying the given item as being one of an augmented set of classes, the augmented set of classes including the set of classes and the new class.

In some embodiments of the processor, the processor is further configured to determine a predicted class for the given item using the modified classification model, the predicted class being the new class.

In some embodiments of the processor, the first classifier is a first binary classifier configured to classify the given item as being of the first class or the other class.

In some embodiments of the processor, the first class is a plurality of first classes, the plurality of first classes being unique to the first classifier amongst the set of classifiers.

In some embodiments of the processor, the new classifier is a new binary classifier configured to classify the given item as being of the new class or the other class.

In some embodiments of the processor, the new class is a plurality of new classes, the plurality of new classes being mutually exclusive with the set of classes.

In some embodiments of the processor, determining the predicted class further comprises submitting the given item to each classifier within the augmented set of classifiers; obtaining individual classification outputs from each classifier; determining the predicted class of the given item using the individual classification outputs.

In some embodiments of the processor, the processor is further configured to extract modality data from the given item using a modality extractor model; extract a plurality of features from the modality data using a feature extractor model. Furthermore, determining the predicted class by the processor comprises inputting the plurality of features into the modified classification model; and outputting by the modified classification model, the predicted class for the given item.

In some embodiments of the processor, the new classifier is at least one of: Support Vector Machine (SVM) model, eXtreme Gradient Boosting (XGBoost) model, Multilayer Perceptron (MLP) model, Convolutional Neural Network (CNN), Recurrent Neural Network (RNN), and Transformer-based model.

In some embodiments of the processor, the modality data includes at least one of: text, images, charts and tables.

In some embodiments of the processor, the modality extractor model is at least one of: Long Short-Term Memory (LSTM) network for character recognition in Optical Character Recognition (OCR) tasks; a text extraction model for extracting text content from Portable Document Format (PDF) files.

In some embodiments of the processor, the feature extractor model is at least one of: Bidirectional Encoder Representations from Transformers (BERT), Vision Transformer (ViT), Robustly Optimized BERT Pretraining approach (ROBERTa), and Generative Pretrained Transformer (GPT).

In some embodiments of the processor, the set of classes include ‘Transaction Record’, ‘Illegal Record’, ‘Normal’, and the new class includes ‘Custom Class’.

In some embodiments of the processor, the processor is further configured to train the classification model on a given training dataset for classifying new items using a remote processor; provide the classification model to the processor instead of the given training dataset.

In at least one aspect of the present technology, there is provided a non-transitory computer-readable medium for storing instructions which upon being executed by a processor, cause the processor to acquire a classification model including a set of classifiers, the classification model for classifying a given item as being of one of a set of classes, a first classifier from the set of classifiers being configured to classify a given item as being of at least one of a first class and an other class, the first class amongst the set of classes being unique to the first classifier amongst the set of classifiers; generate a training dataset including a plurality of training items with associated class labels, the plurality of training items having a new item associated with a class label, the class label being indicative of a new class, the new class being mutually exclusive with the set of classes; train a new classifier using the training dataset for classifying the given item as being of at least one of the new class and the other class; generate a modified classification model based on the classification model and the new classifier, the modified classification model including an augmented set of classifiers, the augmented set of classifiers having the set of classifiers and the new classifier, the modified classification model for classifying the given item as being one of an augmented set of classes, the augmented set of classes including the set of classes and the new class.

In some embodiments of the non-transitory computer-readable medium, the instructions, upon being executed by the processor, cause the processor to determine a predicted class for the given item using the modified classification model, the predicted class being the new class.

In some embodiments of the non-transitory computer-readable medium, the first classifier is a first binary classifier configured to classify the given item as being of the first class or the other class.

In some embodiments of the non-transitory computer-readable medium, the first class is a plurality of first classes, the plurality of first classes being unique to the first classifier amongst the set of classifiers.

In some embodiments of the non-transitory computer-readable medium, the new classifier is a new binary classifier configured to classify the given item as being of the new class or the other class.

In some embodiments of the non-transitory computer-readable medium, the new class is a plurality of new classes, the plurality of new classes being mutually exclusive with the set of classes.

In some embodiments of the non-transitory computer-readable medium, determining the predicted class further comprises submitting the given item to each classifier within the augmented set of classifiers; obtaining individual classification outputs from each classifier; determining the predicted class of the given item using the individual classification outputs.

In some embodiments of the non-transitory computer-readable medium, the instructions, upon being executed by the processor, cause the processor to extract modality data from the given item using a modality extractor model; extract a plurality of features from the modality data using a feature extractor model. Furthermore, determining the predicted class by the processor comprises inputting the plurality of features into the modified classification model; and outputting by the modified classification model, the predicted class for the given item.

In some embodiments of the non-transitory computer-readable medium, the new classifier is at least one of: Support Vector Machine (SVM) model, extreme Gradient Boosting (XGBoost) model, Multilayer Perceptron (MLP) model, Convolutional Neural Network (CNN), Recurrent Neural Network (RNN), and Transformer-based model.

In some embodiments of the non-transitory computer-readable medium, the set of classes include ‘Transaction Record’, ‘Illegal Record’, ‘Normal’, and the new class includes ‘Custom Class’.

In some embodiments of the non-transitory computer-readable medium, the instructions, upon being executed by the processor, cause the processor to train the classification model on a given training dataset for classifying new items using a remote processor; provide the classification model to the processor instead of the given training dataset.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 illustrates the workflow of a sensitive document classification system, in accordance with at least some non-limiting embodiments of the present technology.

FIGS. 3A, 3B, 3C, 3D illustrate the working principle of a novel classification model, in accordance with at least some non-limiting embodiments of the present technology.

FIG. 4 illustrates a representation of an algorithm for training a binary classifier, in accordance with at least some non-limiting embodiments of the present technology.

FIG. 5 illustrates an algorithm used at the inference stage of document classification, in accordance with at least some non-limiting embodiments of the present technology.

FIG. 6A illustrates a conventional document classification method.

FIG. 6B illustrates an approach for document classification facilitated by at least some non-limiting embodiments of the present technology.

FIG. 7 is a scheme-block illustration of a method executed by a processor of the computing device of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

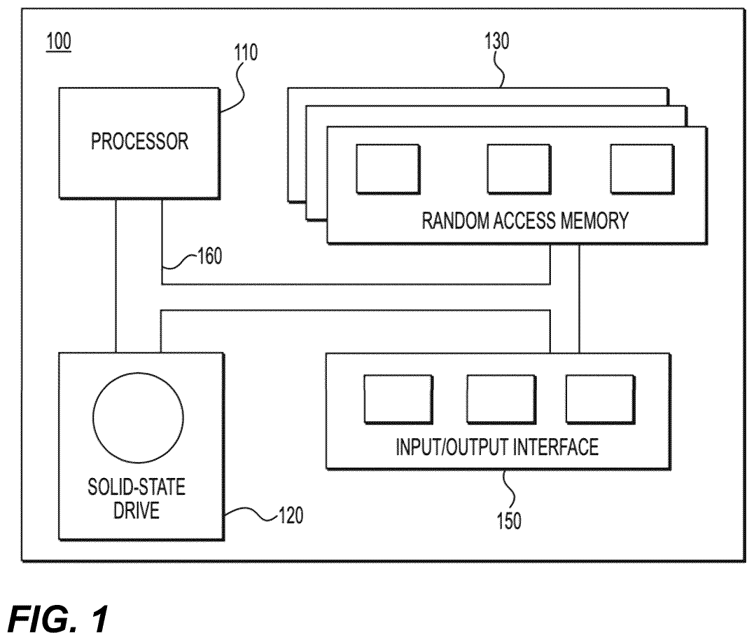

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (Saas). In an IaaS environment, users can rent virtual servers, storage, and other computing resources from a third-party provider, for example. In a PaaS environment, users have access to a platform for developing, running, and managing applications without having to manage the underlying infrastructure.

In a SaaS environment, users can access pre-built software applications that are hosted by a third-party provider, for example. In summary, cloud computing environments offer a range of benefits, including cost savings, scalability, increased agility, and the ability to quickly deploy and manage applications.

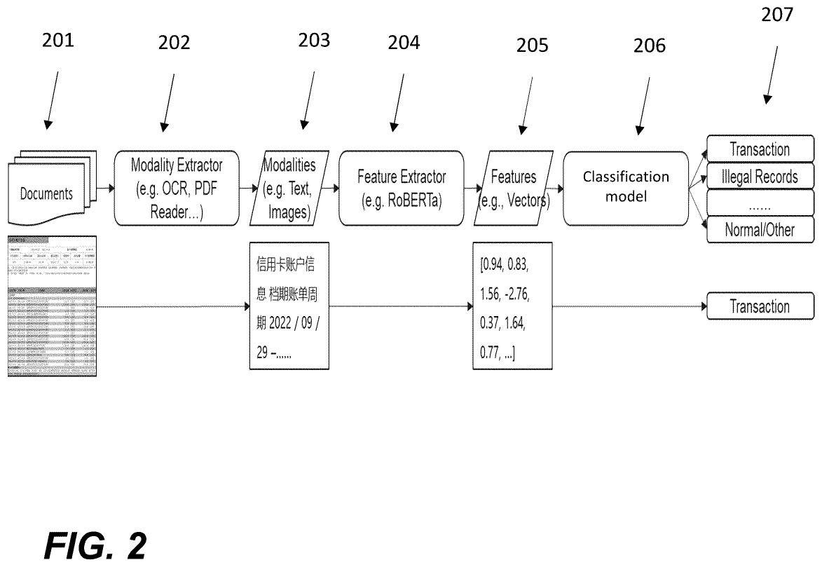

FIG. 2 illustrates the workflow of a sensitive document classification system, in accordance with at least some non-limiting embodiments of the present technology. In this embodiment, the process may begin with input documents 201, which are passed through a modality extractor 202 executed by the processor 110. Examples of such extractors include OCR and PDF readers, which are capable of handling various document formats to extract relevant modalities 203 such as text and images. These modalities are subsequently processed by a feature extractor 204 executed by the processor 110. This feature extraction module may employ Natural Language Processing (NLP) models, such as BERT, ROBERTa, and GPT, Computer Vision (CV) models, like ViT, or multi-modal models, including LayoutLMv3, in order to extract a plurality of features from the input documents 201. The output of the feature extractor 204 is a set of features 205, represented as vectors of real numbers. These vectors are comprehensive, machine-readable representations of the documents' content, capturing the essential characteristics needed for classification.

Then, the processor is configured to employ the classification model 206, which takes these feature vectors as input and categorizes the document into one of the predefined categories 207, such as Transaction, Illegal Records, or Normal/Other, for example. As it will become apparent from the present description, in at least some embodiments there are provided methods and processors for training and using the classification model 206.

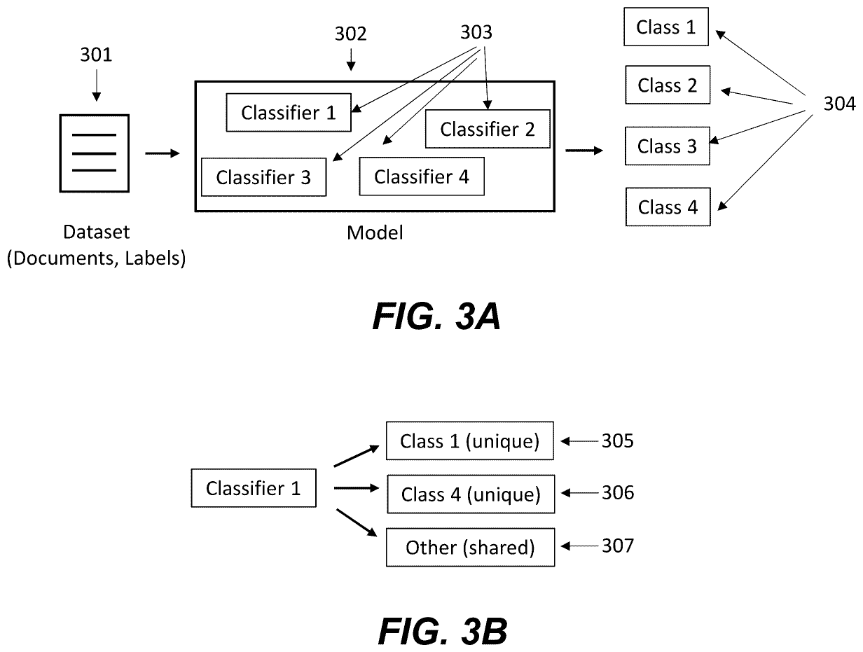

FIGS. 3A, 3B, 3C, 3D illustrate representations of a given classification model, in accordance with at least some non-limiting embodiments of the present technology. A set of classifiers 303 is incorporated in the document classifier model 302 as depicted in FIG. 3A. A new multiclass dataset 301 fed to the classification model 302 by the processor 110 contains documents and labels associated with each document. The labels associated with the documents are from a set of classes ‘Class 1’, ‘Class 2’ (304), etc. In this embodiment, each classifier has a set of classes which is unique to the corresponding classifier and another set which is shared with other classifiers. For example, as illustrated in FIG. 3B, for ‘Classifier 1’, ‘Class 1’ (305) and ‘Class 4’ (306) are unique, not shared with any other classifiers whereas ‘Other’ (307) represents classes which ‘Classifier 1’ shares with other classifiers.

In some embodiments, during training of a given classifier, a document associated with a label corresponding to a class that belongs to that given classifier may be assigned with a value of “1” for that given classifier and “0” for those classifiers whose classes do not correspond to the label associated with the document. For example, as illustrated in FIG. 3C, for a document DOC-1 associated with label C1, ‘Classifier 1’ assigns a value of “1” to DOC-1 while the other classifiers associate a value of “0” to DOC-1. Similarly, for a document DOC-2 associated with label C2, ‘Classifier 2’ assigns a value of “1” to DOC-2 while the other classifiers assign a value of “0” to DOC-2. Hence, in this embodiment, the values (0 or 1) assigned to a given document will be different depending on which classifier is being trained.

When a new dataset 301 is given to the document classification model 302 by the processor 110, each classifier determines which documents in the dataset belong to its unique classes and which documents belong to its shared classes using the label associated with each document. When a document in the dataset 301 is associated with a new label C5, which is indicative of a new class that is mutually exclusive to the pre-existing classes belonging to the pre-trained classifiers, a new training dataset is to be prepared for training a new classifier for label C5. In this embodiment, in the new training dataset, the documents which have been previously used to train the other classifiers will be assigned with new values (0 or 1) and which may be different compared to the values assigned to them in the previous training datasets.

The new training dataset may be used by the processor 110 to train a new classifier for the new document with label C5, thereby generating an augmented classification model (310, FIG. 3D) containing the pre-trained classifiers and the new classifier ‘Classifier 5’. Similarly, it can be said that any new document with a new, mutually exclusive, label may be used to augment the existing classification model, allowing the augmented model to classify a given document as being one of the pre-existing set of classes 304 and the new classes 311.

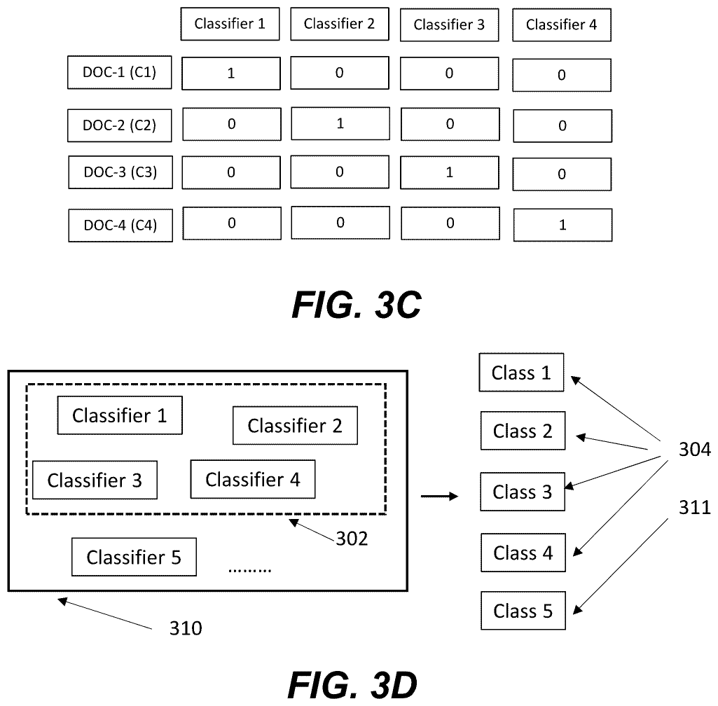

FIG. 4 illustrates a representation of an algorithm which includes a loop 400 involving operations 401, 402, 403, 404 and 405 for training a binary classifier, in accordance with at least some non-limiting embodiments of the present technology. The input of training stage is a multiclass dataset D_{original}= {doc^{j}, y^{j}}_{|D|}, where doc^{j} represents a document and y^{j} denotes its associated label from a set of classes C={C₁, C₂, . . . , C_{C}_{_{|C|}}}.

In this embodiment, at operation 401, for each class Cᵢ, the processor 110 groups all documents with same label (y^{j}=Cᵢ) together forming Doc_{c}_{ᵢ}, and group documents that are not labeled with Cᵢ together to form Doc_{Other}.

In this embodiment, at operation 402, by employing a modality extractor and a deep learning-based feature extractor, the processor 110 converts Doc_{C}_{ᵢ} and Doc_{Other} into X_{C}_{ᵢ} and X_{Other}, where X is a matrix and each row of X refers to the feature (a vector of real numbers) of a document.

Furthermore, in this embodiment, at operation 403, the processor 110 reconstructs the dataset into binary classification dataset

$$D = \{ ( {X}_{{C}_{i}}^{1} , 1 ) , ( {X}_{{C}_{i}}^{2} , 1 ) , … , ( {X}_{O t her}^{1} , 0 ) , ( {X}_{O t h e r}^{2} , 0 ) , … \} .$$

Furthermore, In this embodiment, at operation 404, the processor 110 trains a machine/deep learning algorithm with this reconstructed binary dataset. In this embodiment, after completing the training process, at operation 405, the processor 110 stores the trained binary classifiers in an estimator map for future reference.

In this embodiment, after the training stage, each trained classifier h_{C}_{ᵢ} is able to predict the probability whether the given document belongs to the class Cᵢ. Since feature extractor are frozen (not tuned) and each h_{C}_{ᵢ} 's training process is independent of one another, each h_{C}_{ᵢ} can be trained in parallel and/or consecutively.

Furthermore, should a user wish to train a new customized classifier, the training process will not impact the previously trained classifiers. The source of Doc_{Other} may not be limited within the multiclass dataset D_{original}. Optionally, it can also be synthetic such as generated by Large Language Models or other data augmentation or synthesis method/tools, without departing from the scope of the present technology.

Although FIG. 4 demonstrates the training algorithm for a binary classifier, the scope of the present disclosure is not limited to binary classifiers—that is, in some embodiments of the present technology, one or more classifiers can be multiclass classifiers. For instance, each time two classes Cᵢ and Cᵢ₊₁ are processed, Doc_{C}_{ᵢ} can be expanded as Doc_{C}_{ᵢ} and Doc_{C}_{ᵢ₊₁}. Similarly, X_{C}_{ᵢ} can be generalized to X_{C}_{ᵢ} and X_{C}_{ᵢ₊₁}. As a result, the classifier would be a multiclass classifier

$${h}_{{C}_{i} , {C}_{i + 1}}$$

which predicts the possibility of a given document belonging to Cᵢ and Cᵢ₊₁.

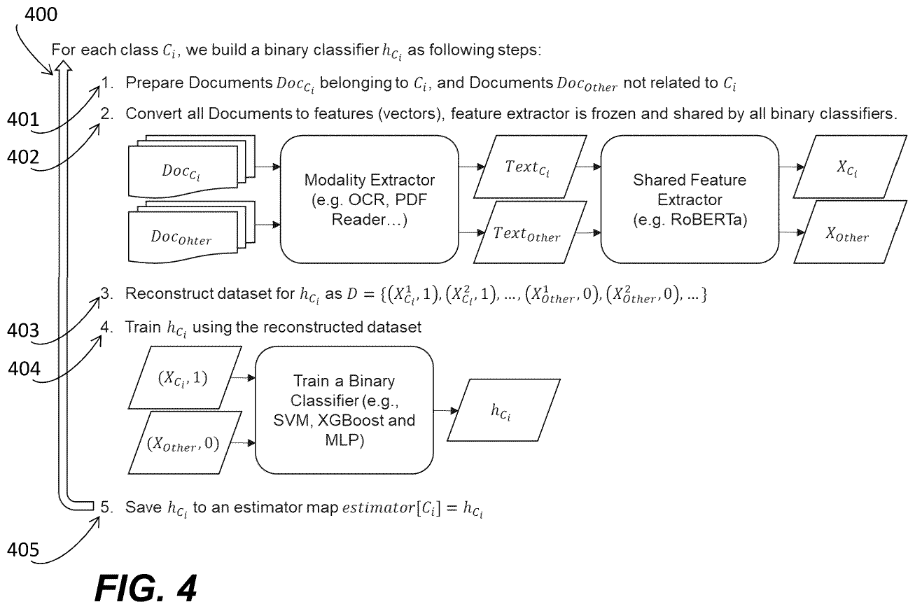

FIG. 5 illustrates an algorithm 500 used at the inference stage of document classification, in accordance with at least some non-limiting embodiments of the present technology. In this embodiment, during the inference stage, at operation 501, each testing document Docₜₑₛₜ is converted into a feature/vector Xₜₑₛₜ by the same modality extractor and feature extractor used in the training stage. Next, at operation 502, the processor 110 may feed Xₜₑₛₜ into all classifiers stored in the estimator map and obtain a plurality of probabilities P={P_{C}_{₁}, P_{C}_{₂}, . . . . P_{C}_{_{|C|}})}, where each P_{C}_{ᵢ} denotes the probability of Docₜₑₛₜ belonging to Cᵢ. In some embodiments, it can be said that the processor may submit a given item to each classifier within the augmented set of classifiers and in response obtain individual classification output from respective classifiers where the individual classification output is the plurality of probabilities P.

In this embodiment, at operation 503, the processor 110 calculates the maximum of P as Pₘₐₓ. If Pₘₐₓ is less than a threshold (which is a hyperparameter tuned by validation data or set manually), the classification model considers Docₜₑₛₜ as belonging to unknown class, meaning that it does not belong to any predefined classes in the training set. Otherwise, Docₜₑₛₜ belongs to the class with highest probability.

At least some embodiments of this method may be generalized to implementation with multilabel classification. For instance, if Pₘₐₓ is larger than the threshold, the classification model determines that Docₜₑₛₜ belongs to all the classes whose probabilities are larger than the threshold.

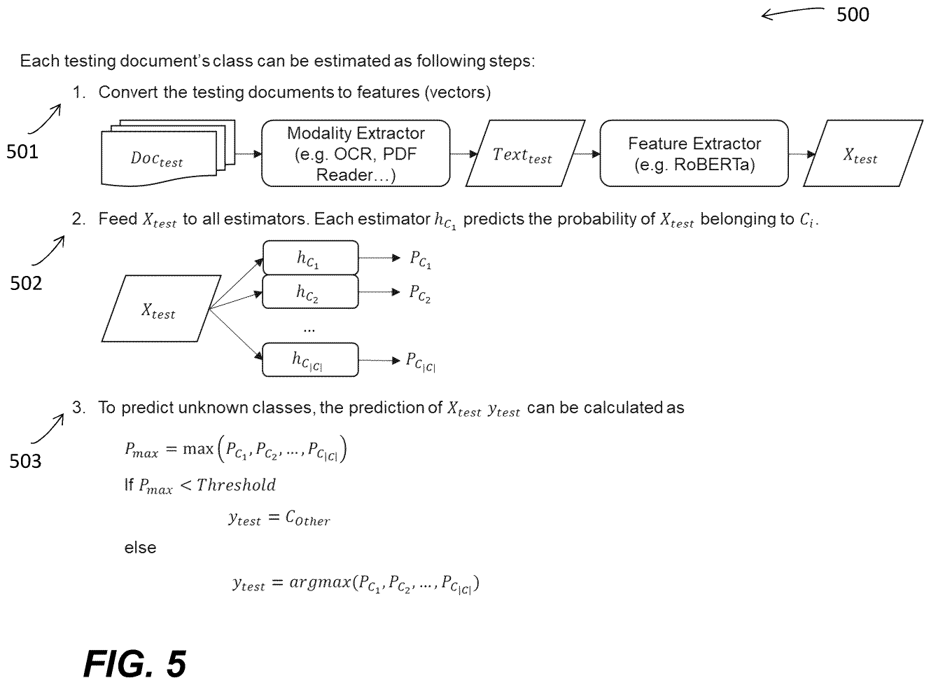

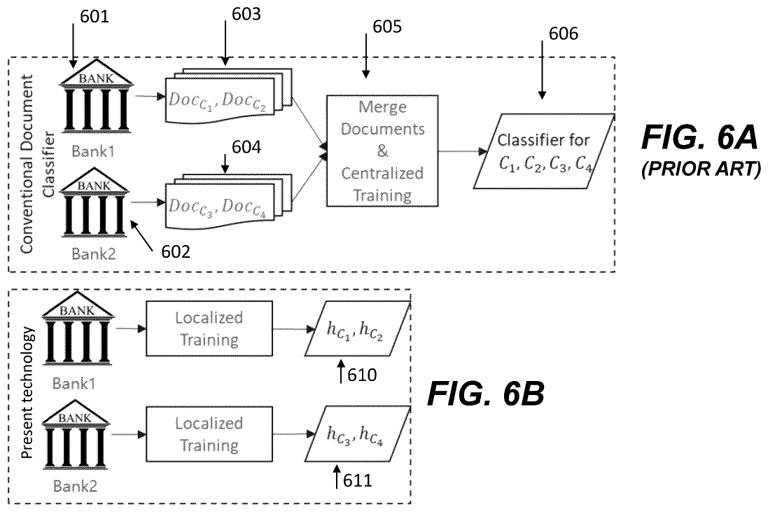

FIG. 6A illustrates a conventional document classification and FIG. 6B illustrates an approach for document classification facilitated by at least some non-limiting embodiments of the present technology.

The traditional method, depicted in FIG. 6A, involves data owners, such as Bank1 (601) and Bank2 (602), who each possess documents of various classes, for example, Doc_{C1}, Doc_{C2} from Bank1 (603) and Doc_{C3}, Doc_{C4} from Bank2 (604). These documents are merged to form a centralized dataset, upon which a classifier 606 for classes C1, C2, C3, and C4 is trained.

Conversely, the present technology, illustrated in FIG. 6B, showcases localized training, where each data owner, such as Bank1 and Bank2, conducts independent classifier training on their respective datasets. This localized training results in classifiers h_{C1}, h_{C2} (610) for Bank1 and h_{C3}, h_{C4} (611) for Bank2, which are then utilized to classify documents pertaining to their respective classes without the need to merge datasets for centralized training. This approach circumvents the need for data sharing, thereby preserving the confidentiality of the data.

At least some embodiments of the present technology may offer a solution in the field of document classification by enabling data owners to maintain the sovereignty of their data while still benefiting from a sophisticated classification model that is both scalable and adaptable to the introduction of new data classes.

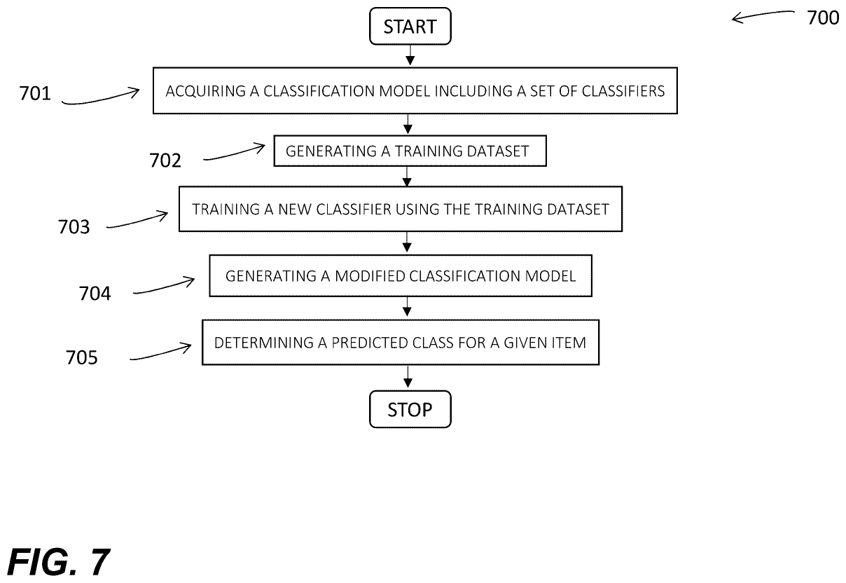

FIG. 7 is a is a flow diagram of a method 700 for classifying documents. In one or more aspects, the method 700 or one or more steps thereof may be performed by the processor 110 of the computer system 100. The method 600 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 700 begins at operation 701 with acquiring a classification model including a set of classifiers, the classification model for classifying a given item as being of one of a set of classes, a first classifier from the set of classifiers being configured to classify a given item as being of at least one of a first class and an other class, the first class amongst the set of classes being unique to the first classifier amongst the set of classifiers. In some embodiments, the first classifier may be a first binary classifier. In other embodiments, the first class may be a plurality of first classes.

For example, in one embodiment with the reference to FIG. 3A and FIG. 3B, the processor 110 could acquire the classification model 302 which includes a set of classifiers 303 for classifying the given item 301 as being of one of a set of classes 304. From the set of classifiers 303, the first classifier, for example, Classifier 1, could be a binary classifier configured to classify the given item 301 as being of at least one of a first class, for example, Class 1 (305) which is unique to Classifier 1, and an other class 307 which is shared between Classifier 1 and at least another classifier.

The method 700 continues at operation 702 with generating a training dataset including a plurality of training items with associated class labels, the plurality of training items having a new item associated with a class label, the class label being indicative of a new class, the new class being mutually exclusive with the set of classes.

For example, in one embodiment with the reference to FIG. 4, the processor 110 could generate a training dataset using a multiclass dataset D_{original}={doc^{j}, y^{j}}_{|D|} as input, where doc^{j} represents a document and y^{j} denotes its associated label from a set of classes C={C₁, C₂, . . . , C_{|C|}}. In this embodiment, at operation 401, for each class Cᵢ, the processor 110 could group all documents with same label (y^{j}=Cᵢ) together forming Doc_{C}_{ᵢ}, and group documents that are not labeled with Cᵢ together to form Doc_{Other}. In this embodiment, at operation 402, by employing a modality extractor and a deep learning-based feature extractor, the processor 110 could convert Doc_{C}_{ᵢ} and Doc_{Other} into X_{C}_{ᵢ} and X_{Other}, where X is a matrix and each row of X refers to the feature (a vector of real numbers) of a document. Furthermore, in this embodiment, at operation 403, the processor 110 could reconstruct the dataset into binary classification dataset

$$D = \{ ( {X}_{{C}_{i}}^{1} , 1 ) , ( {X}_{{C}_{i}}^{2} , 1 ) , … , ( {X}_{O t her}^{1} , 0 ) , ( {X}_{O t h e r}^{2} , 0 ) , … \}$$

and use this reconstructed binary dataset as a training dataset.

The method 700 continues at operation 703 with training a new classifier using the training dataset for classifying the given item as being of at least one of the new class and the other class. In some embodiments, the new classifier may be a new binary classifier and the new class may be a plurality of new classes, and where the plurality of new classes are mutually exclusive with the set of classes.

For example, in one embodiment with the reference to FIG. 4, after completing operations 401-403 for generating a binary training dataset, the processor 110, at operation 404, could train a machine/deep learning model with this binary dataset. In this embodiment, after completing the training process, at operation 405, the processor 110 could store the trained binary classifiers in an estimator map for future reference.

The method 700 continues at operation 704 with generating a modified classification model based on the classification model and the new classifier, the modified classification model including an augmented set of classifiers, the augmented set of classifiers having the set of classifiers and the new classifier, the modified classification model for classifying the given item as being one of an augmented set of classes, the augmented set of classes including the set of classes and the new class.

For example, in one embodiment with the reference to FIG. 3D, the processor 110 could generate a modified classification model 310 based on the classification model 302 and the new classifier (Classifier 5). The modified classification model 310 could include the set of classifiers (Classifier 1, Classifier 2, Classifier 3, Classifier 4) and the new classifier (Classifier 5).

The method 700 continues at operation 705 with determining a predicted class for the given item using the modified classification model, the predicted class being the new class. The determining the predicted class may comprise the processor 110 configured to submit the given item to each classifier within the augmented set of classifiers, obtain individual classification outputs from each classifier, and determine the predicted class of the given item using the individual classification outputs.

For example, in one embodiment with the reference to FIG. 3D and FIG. 5, the processor 110 could determine a predicted class for the given item using the modified classification model 310, the predicted class being the new class (Class 5). In this embodiment, in order to determine the predicted class, the processor 110 could utilize an algorithm, for example, algorithm 500 illustrated in FIG. 5. In this embodiment, the processor 110, at operation 501, could convert each testing document Docₜₑₛₜ into a feature/vector Xₜₑₛₜ by the same modality extractor and feature extractor used in the training stage. Next, at operation 502, the processor 110 could feed Xₜₑₛₜ into all classifiers stored in the estimator map and obtain a plurality of probabilities P={P_{C}_{₁}, P_{C}_{₂}, . . . . P_{C}_{_{|C|}})}, where each P_{C}_{ᵢ} denotes the probability of Docₜₑₛₜ belonging to Cᵢ. In this embodiment, at operation 503, the processor 110 could calculate the maximum of P as Pₘₐₓ. If Pₘₐₓ is less than a threshold (which is a hyperparameter tuned by validation data or set manually), the classification model 310 could consider Docₜₑₛₜ as belonging to unknown class, meaning that it does not belong to any predefined classes in the training set. Otherwise, the classification model 310 could consider Docₜₑₛₜ as belonging to the class with highest probability.

While the above-described implementations have been described and shown with reference to particular operations performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that at least some of the operations of the method 700 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of classifying documents, the method executable by a processor, the method comprising:
acquiring a classification model including a set of classifiers, the classification model for classifying a given item as being of one of a set of classes,
a first classifier from the set of classifiers being configured to classify a given item as being of at least one of a first class and an other class, the first class amongst the set of classes being unique to the first classifier amongst the set of classifiers;
generating a training dataset including a plurality of training items with associated class labels, the plurality of training items having a new item associated with a class label, the class label being indicative of a new class, the new class being mutually exclusive with the set of classes;
training a new classifier using the training dataset for classifying the given item as being of at least one of the new class and the other class; and
generating a modified classification model based on the classification model and the new classifier,
the modified classification model including an augmented set of classifiers, the augmented set of classifiers having the set of classifiers and the new classifier, the modified classification model for classifying the given item as being one of an augmented set of classes, the augmented set of classes including the set of classes and the new class.

2. The method of claim 1, further comprising determining a predicted class for the given item using the modified classification model, the predicted class being the new class.

3. The method of claim 1, wherein the first classifier is a first binary classifier configured to classify the given item as being of the first class or the other class.

4. The method of claim 1, wherein the first class is a plurality of first classes, the plurality of first classes being unique to the first classifier amongst the set of classifiers.

5. The method of claim 1, wherein the new classifier is a new binary classifier configured to classify the given item as being of the new class or the other class.

6. The method of claim 1, wherein the new class is a plurality of new classes, the plurality of new classes being mutually exclusive with the set of classes.

7. The method of claim 1, wherein the determining the predicted class further comprises:
submitting the given item to each classifier within the augmented set of classifiers;
obtaining individual classification outputs from each classifier;
determining the predicted class of the given item using the individual classification outputs.

8. The method of claim 1, wherein the method further comprises:
extracting modality data from the given item using a modality extractor model;
extracting a plurality of features from the modality data using a feature extractor model;
and wherein the determining the predicted class comprises:
inputting the plurality of features into the modified classification model; and
outputting by the modified classification model, the predicted class for the given item.

9. The method of claim 1, wherein the new classifier is at least one of: Support Vector Machine (SVM) model, extreme Gradient Boosting (XGBoost) model, Multilayer Perceptron (MLP) model, Convolutional Neural Network (CNN), Recurrent Neural Network (RNN), and Transformer-based model.

10. The method of claim 8, wherein the modality data includes at least one of: text, images, charts and tables.

11. The method of claim 8, wherein the modality extractor model is at least one of:
Long Short-Term Memory (LSTM) network for character recognition in Optical Character Recognition (OCR) tasks;
a text extraction model for extracting text content from Portable Document Format (PDF) files.

12. The method of claim 8, wherein the feature extractor model is at least one of: Bidirectional Encoder Representations from Transformers (BERT), Vision Transformer (ViT), Robustly Optimized BERT Pretraining approach (ROBERTa), and Generative Pretrained Transformer (GPT).

13. The method of claim 1, wherein the method further comprises:
training the classification model on a given training dataset for classifying new items using a remote processor;
providing the classification model to the processor instead of the given training dataset.

14. A processor for classifying documents, the processor being configured to:
acquire a classification model including a set of classifiers, the classification model for classifying a given item as being of one of a set of classes,
a first classifier from the set of classifiers being configured to classify a given item as being of at least one of a first class and an other class, the first class amongst the set of classes being unique to the first classifier amongst the set of classifiers;
generate a training dataset including a plurality of training items with associated class labels, the plurality of training items having a new item associated with a class label, the class label being indicative of a new class, the new class being mutually exclusive with the set of classes;
train a new classifier using the training dataset for classifying the given item as being of at least one of the new class and the other class; and
generate a modified classification model based on the classification model and the new classifier,
the modified classification model including an augmented set of classifiers, the augmented set of classifiers having the set of classifiers and the new classifier, the modified classification model for classifying the given item as being one of an augmented set of classes, the augmented set of classes including the set of classes and the new class.

15. The processor of claim 14, wherein the processor is further configured to determine a predicted class for the given item using the modified classification model, the predicted class being the new class.

16. The processor of claim 14, wherein the first classifier is a first binary classifier configured to classify the given item as being of the first class or the other class.

17. The processor of claim 14, wherein the determining the predicted class further comprises:
submitting the given item to each classifier within the augmented set of classifiers;
obtaining individual classification outputs from each classifier;
determining the predicted class of the given item using the individual classification outputs.

18. The processor of claim 14, wherein the processor is further configured to:
extract modality data from the given item using a modality extractor model;
extract a plurality of features from the modality data using a feature extractor model;
and wherein the determining the predicted class comprises:
inputting the plurality of features into the modified classification model; and
outputting by the modified classification model, the predicted class for the given item.

19. The processor of claim 14, wherein the processor is further configured to:
train the classification model on a given training dataset for classifying new items using a remote processor;
provide the classification model to the processor instead of the given training dataset.

20. A non-transitory computer-readable medium comprising instructions which upon being executed by a processor, cause the processor to:
acquire a classification model including a set of classifiers, the classification model for classifying a given item as being of one of a set of classes,
a first classifier from the set of classifiers being configured to classify a given item as being of at least one of a first class and an other class, the first class amongst the set of classes being unique to the first classifier amongst the set of classifiers;
generate a training dataset including a plurality of training items with associated class labels, the plurality of training items having a new item associated with a class label, the class label being indicative of a new class, the new class being mutually exclusive with the set of classes;
train a new classifier using the training dataset for classifying the given item as being of at least one of the new class and the other class; and
generate a modified classification model based on the classification model and the new classifier,
the modified classification model including an augmented set of classifiers, the augmented set of classifiers having the set of classifiers and the new classifier, the modified classification model for classifying the given item as being one of an augmented set of classes, the augmented set of classes including the set of classes and the new class.
